(19) United States
(12) Patent Application Publication
(10) Pub. No.: US 2026/0228826 A1
(43) Pub. Date: Aug. 6, 2026

(54) Platform Verifiable Micro Markets for Creative Attention, Compliance Proofs, and Autonomous Agent Orchestration

(71) Applicant: dario chang, Doral, FL (US)

(72) Inventor: dario chang, Doral, FL (US)

(21) Appl. No.: 19/419,836

(22) Filed: Dec. 15, 2025

(51) Int. Cl. G06Q 40/04

(52) U.S. Cl. CPC G06Q 40/043; G06Q 40/042

(57) ABSTRACT

A computer-implemented platform integrates predictive scoring, verifiable proofs, programmable settlement, and configurable micromarkets to monetize certified engagement and operational events. A predictive scoring pillar generates canonical IPS tokens derived from Cycle Hits and Hits History primitives. A multimodal Proof Registry records verifiable proofs, verifier metadata, Merkle anchors, and composite verification outcomes. An adaptive settlement engine conditions value transfer on composite_verification_records and issues settlement_finality_proofs. A MicroMarket Generator instantiates markets with configurable discovery, pricing, liquidity, governance, and settlement policies. Selective disclosure, cross-chain finality, reputation scoring, anomaly detection, and compliance attestations are supported. The platform provides APIs, SDKs, and certification tooling enabling token issuance, proof submission, composite verification, and deterministic settlement orchestration across heterogeneous rails.

### CROSS REFERENCE AND LINEAGE

This application is a continuation-in-part of U.S. application Ser. No. 10/605,894, filed Nov. 4, 2003 (abandoned; petition to revive filed), and claims benefit under 35 U.S.C. 120 to that application. This application is also a continuation-in-part of U.S. application Ser. No. 19/331,115, filed Sep. 17, 2025, which is currently pending. Each of the foregoing applications is incorporated herein by reference in its entirety. This application further claims priority and is a continuation-in-part of Applicant's earlier filings, including the 2003 parent application that disclosed Cycle Hits, Hits History, rotation groups, interactive multimedia Ads, and replayable histories. The present specification explicitly maps modern modules to those parent primitives to show lineage and to maximize blocking power across the Applicant's portfolio.

### FIELD OF THE INVENTION

Computer-implemented systems and methods for monetizing verified engagement and operational resources by combining predictive scoring, verifiable proofs, programmable settlement, and market mechanisms to orchestrate autonomous agents and digital assets.

### BACKGROUND

Digital advertising and agent marketplaces rely on engagement scoring, rotation, and auditability to allocate scarce attention and runtime resources. The 2003 parent introduced Cycle Hits, Hits History, rotation groups, and interactive Ads as primitives for placement and audit. Modern platforms monetize these primitives but often lack standardized, verifiable proofs and programmable settlement that tie monetization to auditable evidence.

### SUMMARY OF THE INVENTION

The invention provides a layered platform comprising: a predictive scoring pillar producing IPS tokens anchored to Hits History and Cycle Hits; a multimodal Proof Registry that records verifiable proofs and verifier metadata; an adaptive settlement engine that conditions value transfer on composite proof bundles; a MicroMarket Generator that instantiates configurable markets; sovereign policy agents that enforce jurisdictional rules and mint Portfolio Provenance Tokens; simulation sandboxes for certification; and a developer integration layer with SDKs, a schema registry, and certification tooling.

### Predictive Scoring Pillar and IPS Token Morphology

The predictive scoring pillar fuses Cycle Hits and Hits History primitives to produce IPS tokens that represent canonical, auditable engagement and operational metrics. Each IPS token comprises fields including, but not limited to: ips_token_id, ips_value, timestamp, provenance_digest, confidence_interval, freshness_score, viewability_score, dwell_time_ms, heatmap_digest, engagement_events_digest, rotation_group, sustainability_score, compliance_status, anomaly_detection_digest, and credential_reference. IPS tokens are serialized in a canonical JSON form and hashed (for example, using SHA256) to produce tamper-evident digests stored in the Proof Registry. IPS tokens support versioning and schema evolution via a schema registry. Freshness_score is computed from Hits History timestamps and decay functions to prioritize recent engagement for rotation and settlement.

### Canonical Token Examples and Schemas

Example canonical token (illustrative, plain text):
token_id: tk_0001; timestamp: 2025-12-13T14:22:00Z; issuer_id: issuer_42;
visual_metrics: viewability_score=0.92, dwell_time_ms=4200;
rotation_group=rg_A; confidence_interval=0.95; freshness_score=0.87;
market_metadata: market_id=mkt_7, policy_version=v1.

Provenance digest generation (plain text): provenance_digest=SHA256(canonical_bytes)

### Multimodal Proof Registry

The Proof Registry records verifiable proofs and receipts that anchor IPS tokens to evidence. Proof entries include proof type, proof payload, verifier identity, verifier signature, Merkle root references, timestamps, jurisdiction tags, and optional regulator signatures. Supported proof families include zero-knowledge proofs (SNARK, STARK), trusted execution environment attestations (SGX, TrustZone, SEV), multiparty computation proofs, homomorphic encryption attestations, regulator-signed receipts, oracle attestations, and machine-learning anomaly detection proofs. The Proof Registry supports composite proof bundles and indexes entries by token identifiers, provenance digests, market identifiers, and jurisdictional tags. APIs expose proof query, replay, and certified receipt functions; verifier reputation metadata and staking information are supported.

### Adaptive Settlement Engine and Escrow Semantics

The settlement engine conditions monetization on verified proofs recorded in the Proof Registry. Settlement mechanisms include escrow contracts, atomic commit protocols, probabilistic settlement ledgers, regulator-certified clearinghouses, and adaptive escrow engines. Escrow contracts may be implemented as smart contracts or off-chain contractual arrangements with on-chain proof anchoring. Atomic commit semantics ensure proof verification and value transfer occur atomically across settlement rails. Probabilistic settlement ledgers permit micropayment scaling while anchoring representative proofs. Adaptive escrow engines adjust release conditions and fee schedules based on risk, sustainability, compliance, and historical replay outcomes. Settlement supports multicurrency flows and cross-chain bridges; dispute workflows integrate escrow holds, arbitration agent invocation, and conditional remediation. Settlement receipts are cryptographically signed by the settlement coordinator and settlement finality proofs are recorded in the Proof Registry.

### Micromarket Generator Expanded Components

The MicroMarket Generator instantiates markets and submarkets with configurable market mechanics, discovery, pricing, liquidity, governance, and settlement policies. Discovery and Matching indexes offers, bids, and certified assets by canonical proof types, jurisdiction, sustainability score, freshness, price, and reputation; multi-attribute matching produces ranked candidate matches. Pricing and Market Mechanics support sealed bid, Dutch, Vickrey, continuous order book, bonding curves, dynamic reserve pricing, batch settlement, and micropayment channels; pricing models may incorporate sustainability premiums, compliance surcharges, and programmable royalty splits. Liquidity and Secondary Markets support order books, fractionalization, programmable royalties, staking and bonding, and market maker mechanisms; secondary transfers and royalty receipts are recorded in the Proof Registry. Governance modules support policy updates, voting, arbitration, dispute workflows, and insurance/escrow dispute funds; governance actions and dispute receipts are recorded in the Proof Registry.

### Market Types and Commercial Modules

Creative Attention Markets monetize certified visual metrics; Visual Metrics Licensing Markets license measurement pipelines; GPU/Runtime Markets monetize certified runtimes and GPU cycles; Retail Fulfillment Markets bundle placement with verified delivery proofs; Sustainability Credit Markets trade verified carbon reductions; Synthetic Data and Simulation Markets sell certified datasets and sandboxes; Compliance Bundle Markets package jurisdictional certification harnesses; Identity and Credential Markets issue and trade verifiable credentials; Robotics Task Markets monetize certified robotic tasks; Developer Services Markets monetize SDKs, certification, and white-label deployments.

### Compliance, Sovereign Agents and Portfolio Provenance Tokens

Sovereign policy agents implement jurisdictional adapters, route workloads to compliant enclaves, and issue compliance receipts. Portfolio Provenance Tokens (PPTs) represent bundles of compliance attestations and certification badges and are revocable upon compliance changes; PPT events are discoverable via the Proof Registry.

### Simulation Sandboxes and Certification

Sandboxes execute certified workflows to produce risk metrics, remediation recommendations, and regulator-facing reports; outputs include certification badges and replayable logs anchored in the Proof Registry.

### Identity, Credentials and Privacy Fabric

The platform issues decentralized identifiers and verifiable credentials; selective disclosure protocols enable attribute proofs without revealing full identity; lifecycle events are recorded for audit.

### Adversarial Robustness and Fraud Prevention

Anomaly detection, fraud scoring, quarantine workflows, retraining via federated learning gated by proof attestations, and privacy-preserving techniques (MPC, differential privacy) are integrated.

### Oracles, External Data and Interoperability

Trusted oracles provide attestations for delivery confirmations, carbon metrics, exchange rates, and regulatory notices; oracle attestations are recorded as proofs. Cross-chain bridges and canonical token mapping enable atomic cross-chain settlement; interoperability adapters translate proof formats while preserving provenance digests.

### Governance, Dispute Resolution and Insurance

Governance actions and votes are recorded; arbitration agents produce signed dispute receipts that trigger escrow remediation or insurance payouts; insurance and risk pools underwrite delivery or proof failures.

### Performance, SLAs and QoS

Markets may define service level agreements; SLA attestations and breach receipts are recorded and may trigger penalties or refunds.

### Developer and Operator Tooling

SDKs, APIs, webhooks, certification test harnesses, sandbox environments, white-label options, automated proof generation libraries, verifier connectors, and analytics dashboards are provided.

### Economic Models, Royalties and Incentives

Programmable royalties, incentive programs, staking and slashing, bonding curves, and liquidity incentives support market depth and align behavior.

### Privacy, Data Minimization and Selective Disclosure

Default data minimization, selective disclosure proofs, encrypted metadata, and privacy proofs recorded in the Proof Registry enable audit without revealing underlying data.

### Reputation, Auditing and Investor Protections

Reputation scores combine proof outcomes, disputes, SLA performance, and third-party attestations; investor dashboards aggregate proof-anchored revenue streams and compliance posture; audit trails and replayable histories provide forensic reconstruction.

### Enablement Examples and Representative Workflows

Example workflows illustrate token issuance, proof recording, market matching, composite proof verification, atomic settlement, cross-chain commits, dispute arbitration, and regulator replay.

### Lineage and Parent Mapping Summary

The platform explicitly maps modern modules to parent primitives to maximize blocking power: interactive Ads map to interactive Ad Module and IPS visual fields; Hits History grouping maps to predictive scoring and IPS provenance and freshness fields; rotation groups map to rotation gateway and rotation_group fields; storage and replay map to Proof Registry replay and audit.

### Anticipated Variations and Equivalents

References to specific technologies are exemplary; equivalents performing substantially the same function are covered. Terminology variants are treated as semantically equivalent where they fulfill canonical roles. The platform supports incremental deployment.

### Security, Scalability and Operational Considerations

Tamper-evident hashing, secure key management, enclave attestations, verifier identity management, probabilistic settlement aggregation, off-chain batching, rollups, caching of proof digests, health checks, proof freshness monitors, SLA trackers, and automated remediation workflows are described.

### DETAILED IMPLEMENTATION

Canonical token serialization. Tokens are generated by serializing a canonical token schema in a fixed canonical order: token identifier; timestamp; issuer identifier; canonical visual metric fields; rotation_group; confidence_interval; freshness_score; and market metadata. The serialized bytes are then hashed using a collision-resistant hash function (for example SHA256) to produce a provenance_digest.

Merkle anchoring and registry storage. Provenance_digests are aggregated into a Merkle tree; the Merkle root is recorded in a tamper-evident Proof Registry together with a Merkle leaf pointer for each token to enable efficient proof retrieval and replay.

Indexed proof descriptor. Each incoming proof is mapped to a normalized proof descriptor containing at least: proof_type; issuer_id; issuance_time; confidence_value; jurisdiction; disclosure_descriptor; and merkle_leaf_pointer. The descriptor is indexed to support search, filtering, and interoperability across proof families.

Heterogeneous proof ingestion. The Proof Registry accepts heterogeneous proof families by mapping each proof to the normalized descriptor and storing a signed verifier receipt and Merkle leaf pointer for the proof, enabling unified handling of zero-knowledge proofs, TEE attestations, MPC outputs, oracle receipts, regulator receipts, and anomaly detection outputs.

Composite proof verification. A composite proof verifier normalizes each proof's confidence_value, applies configurable weights (market or policy defined), aggregates the weighted confidences using a robust aggregator or weighted sum, and computes a composite_verification_score. The verifier emits a composite_verification_record when the composite_verification_score meets or exceeds a market threshold. Robust aggregation options (trimmed mean, median, or other outlier-resistant aggregators) are expressly supported.

Threshold and policy configuration. Markets and micro-markets expose configurable proof thresholds, weight profiles, and aggregation policies. Thresholds and weight profiles are stored as market policy records in the Proof Registry and are referenced by composite_verification_records to ensure reproducible verification.

Adaptive settlement orchestration. The adaptive settlement engine listens for composite_verification_records and, when triggered, performs deterministic settlement orchestration: prepare settlement intents on selected rails; coordinate participant acknowledgements; execute an atomic commit protocol (prepare, acknowledge, commit); and record a settlement_finality_proof.

Settlement receipt and recording. Upon commit, the settlement coordinator generates a cryptographically signed settlement receipt that includes provenance_digest, composite_verification_score, settlement_finality_proof, timestamp, and settlement participants. The settlement receipt and finality proof are recorded in the Proof Registry and emitted to market participants and developer webhooks.

Privacy-preserving selective disclosure. disclosure_descriptors enumerate allowed revealed fields for each proof; SDK functions produce selective disclosure proofs that satisfy disclosure_descriptors without exposing raw metadata. Selective disclosure proofs are recorded in the Proof Registry with a disclosure_descriptor pointer limiting revealed fields.

Cross-chain finality and canonical mapping. For cross-chain settlement, canonical token identifiers and provenance_digest values are mapped across ledgers by bridge modules that preserve Merkle pointers; cross-chain commit semantics ensure consistent settlement and record cross-chain finality proofs in the Proof Registry.

Reputation, slashing, and revocation. Reputation scores are computed from historical proof outcomes, dispute records, and SLA performance; slashing and revocation events are recorded as registry events linked to participant identifiers and provenance_digest values, and may trigger automated remediation such as escrow remediation or insurance payouts.

Developer tooling and auditability. SDKs, certification test harnesses, and sandbox environments implement APIs for token minting, proof submission, proof validation, composite score configuration, and settlement orchestration. Audit dashboards expose proof-anchored KPIs and provide reproducible logs for auditors and enforcement actions.

### Closing and Scope Statement

The foregoing description provides a comprehensive and enabling disclosure of the platform, including canonical token serialization, Merkle anchoring, composite verification, adaptive settlement orchestration, cross-chain finality, selective disclosure, and reputation mechanisms. While specific embodiments and examples have been described for clarity, it will be understood that numerous variations, substitutions, and equivalents may be devised without departing from the spirit and scope of the invention. The claims are intended to cover all such modifications and equivalents.

1. A computer-implemented system for proof-anchored monetization and micromarket orchestration, comprising:
a predictive scoring pillar configured to generate canonical tokens by fusing Cycle Hits and Hits History primitives into a canonical token schema;
a Proof Registry implemented as a tamper-evident store that aggregates provenance_digests into a Merkle tree and records a Merkle root anchoring to a ledger;
an indexed proof descriptor module that normalizes incoming proofs and stores for each proof at least: proof_type, issuer_id, issuance_time, confidence_value, jurisdiction, disclosure_descriptor, and merkle_leaf_pointer;
a composite proof verifier configured to normalize confidence values from multiple proof families, apply configurable weight profiles, compute a composite_verification_score, and emit a composite_verification_record when a market threshold is met; and
an adaptive settlement engine configured to listen for composite_verification_records and, upon threshold satisfaction, execute deterministic settlement orchestration including preparing settlement intents, coordinating participant acknowledgements, executing an atomic commit protocol across one or more settlement rails, and issuing a signed settlement_finality_proof;
wherein each canonical token includes fields provenance_digest, confidence_interval, and freshness_score, and wherein monetization or value transfer for a token is conditioned on recording a composite_verification_record and issuance of a settlement_finality_proof.

2. The system of claim 1, wherein the Proof Registry accepts and indexes proof families selected from zero-knowledge proofs, trusted execution environment attestations, multiparty computation outputs, homomorphic encryption attestations, regulator receipts, oracle attestations, and machine-learning anomaly detection proofs, and exposes APIs for proof query, Merkle proof retrieval, and verifier receipt replay.

3. The system of claim 1, wherein the composite proof verifier implements robust aggregation selected from trimmed mean, median, or weighted sum with outlier trimming, and wherein weight profiles are stored as market policy records referenced by composite_verification_records.

4. The system of claim 1, wherein the adaptive settlement engine supports settlement mechanisms selected from escrow smart contracts, two-phase commit across heterogeneous ledgers, probabilistic settlement ledgers, and regulator-certified clearinghouse flows, and records settlement receipts that include provenance_digest, composite_verification_score, settlement_finality_proof, timestamp, and participant identifiers.

5. The system of claim 1, further comprising a MicroMarket Generator configured to instantiate one or more markets with configurable market mechanics, each market exposing market-level proof requirements, aggregation weight profiles, and settlement policies.

6. The system of claim 5, wherein the MicroMarket Generator instantiates markets selected from creative attention markets, visual-metrics licensing markets, GPU/runtime markets, sustainability credit markets, synthetic data markets, and compliance bundle markets.

7. The system of claim 1, further comprising a discovery and matching engine that indexes offers and bids by canonical proof types, jurisdiction, sustainability_score, freshness_score, price, and reputation, and that produces ranked candidate matches using a multi-attribute relevance model that weights matches by proof confidence and token freshness.

8. The system of claim 1, wherein canonical token serialization is performed by serializing token fields in a fixed canonical order and hashing the serialized bytes using a collision-resistant hash function to produce the provenance_digest.

9. The system of claim 1, wherein selective disclosure proofs are generated according to a disclosure_descriptor that enumerates allowed revealed fields, and wherein selective disclosure proofs are recorded in the Proof Registry with a disclosure_descriptor pointer limiting revealed fields.

10. The system of claim 1, further comprising reputation and fraud prevention modules that compute reputation scores from historical proof outcomes, dispute records, and SLA performance, and that record slashing or revocation events in the Proof Registry linked to participant identifiers.

11. A computer-implemented method for proof-conditioned micromarket settlement, comprising:
serializing canonical token data and hashing the serialized bytes to produce a provenance_digest;
recording one or more verifiable proofs in a Proof Registry and storing associated Merkle leaves and a Merkle root anchoring;
computing a composite_verification_score by normalizing confidence values from at least two proof types and applying a market weight profile;
emitting a composite_verification_record when the composite_verification_score meets or exceeds a market threshold; and
executing an atomic commit settlement across one or more settlement rails and issuing a settlement_finality_proof only upon successful verification, and recording the settlement_finality_proof in the Proof Registry.

12. The method of claim 11, wherein computing the composite_verification_score comprises applying conformal prediction or Bayesian ensembling to calibrate confidence intervals recorded in the canonical token.

13. The method of claim 11, wherein executing an atomic commit settlement comprises preparing settlement intents, coordinating participant acknowledgements, performing a two-phase commit across heterogeneous ledgers, and recording cross-chain finality proofs in the Proof Registry.

14. A non-transitory computer-readable medium storing instructions that, when executed by one or more processors, cause the processors to perform the method of claim 11.

15. The medium of claim 14, wherein the instructions further cause the processors to mint Portfolio Provenance Tokens representing bundles of compliance attestations and certification badges, to revoke or update such Portfolio Provenance Tokens upon changes in compliance status, and to record all minting, revocation, and update events in the Proof Registry linked to provenance_digest values.

16. The system of claim 1, wherein the Proof Registry exposes verifier APIs that return signed verification receipts and Merkle proofs enabling regulator replay without transmitting raw personal data.

17. The system of claim 1, wherein the composite proof verifier triggers human-in-the-loop gating for composite_verification_records that fail fairness or adversarial robustness checks, and wherein gating decisions are recorded as tamper-evident audit entries.

18. The system of claim 1, wherein freshness_score is computed from Hits History timestamps using an exponential decay function parameterized by a decay constant and recorded in the canonical token.

19. The system of claim 1, wherein the adaptive settlement engine adjusts release conditions and fee schedules based on computed risk, sustainability_score, and compliance_status, and wherein such adjustments are recorded in settlement receipts.

20. The system of claim 1, wherein Merkle roots are anchored to one or more distributed ledgers and the Proof Registry maintains cross-chain mapping records that preserve provenance_digest values across ledgers.
